(19) United States
(12) Patent Application Publication
(10) Pub. No.: US 2026/0371308 A1
(43) Pub. Date: Nov. 19, 2026

(54) MANAGING WIRELESS COMMUNICATION CHANNELS BASED ON CONTEXTUAL INFORMATION

(71) Applicant: Google LLC, Mountain View, CA (US)

(72) Inventors: Russell William Myers, Marietta, GA (US); Yifei Zhang, Sunnyvale, CA (US)

(21) Appl. No.: 19/209,203

(22) Filed: May 15, 2025

(51) Int. Cl. H04W 64/00; H04W 56/00

(52) U.S. Cl. CPC H04W 64/006; H04W 56/00

(57) ABSTRACT

A method includes generating, by a first computing device, contextual information of the first computing device. The method also includes receiving, by the first computing device and from a cloud system, contextual information of a second computing device. The contextual information of the second computing device being transmitted to the first computing device based on determining that the first computing device is associated with the second computing device. The method additionally includes determining whether a distance between the first computing device and the second computing device satisfies a proximity threshold by comparing the contextual information of the first computing device with the contextual information of the second computing device. The method further includes responsive to determining that the distance satisfies the proximity threshold, broadcasting an advertisement message enabling wireless communication channel initialization between the first computing device and the second computing device.

### BACKGROUND

Computing devices, including wearable devices and mobile devices, frequently communicate with other devices using wireless communication channels. To establish a wireless communication channel, the initiating device transmits a discovery request to identify available peers within range. The receiving device may respond with an acknowledgment, probe request, or connection request. Once both devices detect each other, the devices may perform authentication and association techniques, followed by negotiating connection parameters before entering into an active communication state.

### SUMMARY

In general, techniques of this disclosure are directed to initiating wireless communication channel advertisements based on contextual information. For example, a user account may be associated with a group of account devices including a first device and a second device. The first device and second device may share credentials via a server. The server may receive credentials from the account devices and subsequently disseminates credential information to each of the account devices. According to the present disclosure, the credentials may also include contextual information, where the contextual information is, for example, location information and/or local network information of the respective account device.

The account devices may enable wireless connection advertisement broadcasting based on the contextual information. For instance, the first device may upload GPS data to the server. The server may subsequently provide the first device’s GPS data to other devices of the user’s account, including the second device. The second device may then compare the second device’s GPS data with GPS data of the account devices, including the first device. In response to determining that the second device is within a proximity threshold to another account device (e.g., the first device) the second device may begin broadcasting wireless connection advertisements. In response to determining that the second device is not within the proximity threshold to another account device, the second device may stop broadcasting wireless connection advertisements. In another example, the first device may provide a Wi-Fi SSID of a Wi-Fi network connected to the first device. In response to determining that the first device’s Wi-Fi SSID matches the second device’s Wi-Fi SSID, the second device may begin broadcasting wireless connection advertisements. In this way, account devices may preserve battery by broadcasting wireless connection advertisements only when other devices are within a sufficient range to establish a wireless connection.

In one example, the disclosure is directed toward a method that includes generating, by a first computing device, contextual information of the first computing device. The method further includes receiving, by the first computing device and from a cloud system, contextual information of a second computing device, the contextual information of the second computing device transmitted to the first computing device based on determining that the first computing device is associated with the second computing device. The method also includes determining, by the first computing device, whether a distance between the first computing device and the second computing device satisfies a proximity threshold by comparing at least a portion of the contextual information of the first computing device with at least a portion of the contextual information of the second computing device. The method additionally includes, responsive to determining that the distance satisfies the proximity threshold, broadcasting, by the first computing device, an advertisement message enabling wireless communication channel initialization between the first computing device and the second computing device.

In another example, the disclosure is directed toward a first computing device comprising one or more processors, and one or more storage devices that store instructions. The instructions, when executed by the one or more processors, cause the one or more processors to generate contextual information of a first computing device. The instructions further cause the one or more processors to receive, from a cloud system, contextual information of a second computing device, the contextual information of the second computing device transmitted to the first computing device based on determining that the first computing device is associated with the second computing device. The instructions also cause the one or more processors to determine whether a distance between the first computing device and the second computing device satisfies a proximity threshold by comparing at least a portion of the contextual information of the first computing device with at least a portion of the contextual information of the second computing device. The instructions additionally cause the one or more processors to, responsive to determining that the distance satisfies the proximity threshold, broadcast an advertisement message enabling wireless communication channel initialization between the first computing device and the second computing device.

In another example, the disclosure is directed toward a non-transitory computer-readable storage medium encoded with instructions that, when executed by one or more processors of a first computing device, cause the one or more processors to generate contextual information of a first computing device. The instructions further cause the one or more processors to receive, from a cloud system, contextual information of a second computing device, the contextual information of the second computing device transmitted to the first computing device based on determining that the first computing device is associated with the second computing device. The instructions also cause the one or more processors to determine whether a distance between the first computing device and the second computing device satisfies a proximity threshold by comparing at least a portion of the contextual information of the first computing device with at least a portion of the contextual information of the second computing device. The instructions additionally cause the one or more processors to, responsive to determining that the distance satisfies the proximity threshold, broadcast an advertisement message enabling wireless communication channel initialization between the first computing device and the second computing device.

In another example, the disclosure is directed toward a computer program product for managing wireless communication channels. The computer program product comprises one or more instructions that, when executed by at least one processor of a first computing device, cause the at least one processor to generate contextual information of a first computing device. The one or more instructions further cause the at least one processor to receive, from a cloud system, contextual information of a second computing device, the contextual information of the second computing device transmitted to the first computing device based on determining that the first computing device is associated with the second computing device. The one or more instructions also cause the at least one processor to determine whether a distance between the first computing device and the second computing device satisfies a proximity threshold by comparing at least a portion of the contextual information of the first computing device with at least a portion of the contextual information of the second computing device. The one or more instructions additionally cause the at least one processor to, responsive to determining that the distance satisfies the proximity threshold, broadcast an advertisement message enabling wireless communication channel initialization between the first computing device and the second computing device.

The details of one or more examples of the disclosure are set forth in the accompanying drawings and the description below. Other features, objects, and advantages of the disclosure will be apparent from the description and drawings, and from the claims.

### BRIEF DESCRIPTION OF THE FIGURES

FIG. 1 is a conceptual diagram illustrating an example network of computing elements, in accordance with one or more aspects of this disclosure.

FIG. 2 is a conceptual diagram illustrating an example computing device in wireless communication with other computing elements, in accordance with one or more aspects of this disclosure.

FIG. 3 is a swimlane diagram illustrating an example operation for establishing a wireless communication channel, in accordance with one or more aspects of this disclosure.

FIG. 4 is a flowchart illustrating an example operation for establishing a wireless communication channel, in accordance with one or more aspects of this disclosure.

### DETAILED DESCRIPTION

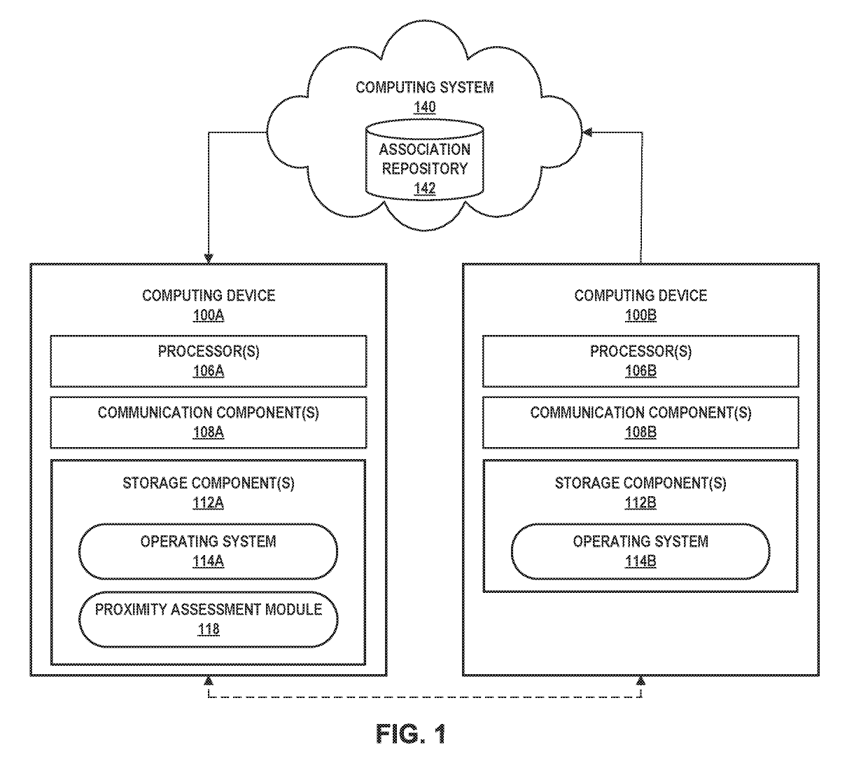

FIG. 1 is a conceptual diagram illustrating an example network of computing elements, in accordance with one or more aspects of this disclosure. In the example of FIG. 1 computing devices 100A and 100B (collectively, “computing devices 100”) may each be an individual mobile or non-mobile computing device. Each of computing devices 100 may be a mobile phone, a tablet computer, a laptop computer, a desktop computer, a server, a mainframe, a set-top box, a television, a wearable device (e.g., a computerized watch, computerized eyewear, computerized headphones, computerized gloves, computerized ring, etc.), a home automation device or system (e.g., an intelligent thermostat or home assistant device), a gaming system, a media player, an e-book reader, a mobile television platform, an augmented reality device, a virtual reality device, a mixed reality device, an automobile navigation or infotainment system, or any other type of mobile, non-mobile, wearable device, or non-wearable device configured to manage wireless communication channels in accordance with techniques of this disclosure. Computing devices 100 may implement various compute resources, e.g., processors, memory, data storage, data buses, input/output controllers, network interfaces, accelerators (e.g., graphics accelerators), and power management units.

Processors 106 may implement functionality and/or execute instructions within computing devices 100. For example, each processor of processors 106 may be a central processing unit (CPU), graphics processing unit (GPU), application processor (AP), digital signal processor (DSP), neural processing unit (NPU), image signal processor (ISP), or microcontroller unit (MCU). Processors 106 may implement computational components including arithmetic logic units, control units, registers, pipelines, execution cores, caches (e.g., L1, L2, and L3), and branch predictors. Processors 106 may operate based on a fetch-decode-execute cycle, where processors 106 retrieve instructions from memory, decode the instructions into operations, and execute the instructions via various functional units. Further, processors 106 may implement an instruction set that defines software and hardware communication at a binary level. In some implementations, processors 106 may include multiple cores and may support multiple threads, and may perform techniques including parallel processing, graphics rendering, and multimedia processing. Processors 106 may execute program code associated with operating systems 114. Additionally, processor 106A may execute program code associated with proximity assessment module 118. Operating systems 114 and proximity assessment module 118 may perform operations described herein using software, hardware, firmware, or a mixture of hardware, software, and firmware.

One or more communication components 108 of computing devices 100 may communicate with external devices via one or more wired and/or wireless networks by transmitting and/or receiving network signals on the one or more networks. Examples of communication components 108 include network interface cards (e.g., Ethernet cards), optical transceivers, radio frequency transceivers, global positioning system (GPS) receivers, or any other device that can send and/or receive information. Other examples of communication components 108 may include short wave radios, cellular data radios, wireless network radios, as well as universal serial bus (USB) controllers.

Computing devices 100 may write data to or read data from one or more storage components 112, where storage components 112 may store execution code associated with operating systems 114 and/or other executable code. Storage components 112 may each include one or more hard disk drives, solid-state drives, hybrid drives, removable media drives, optical drives, and/or any other device configured to store information. In some implementations, storage components 112 may be configured for short-term storage of information as volatile memory and therefore may not retain stored contents if powered off. Examples of volatile memories include random access memory (RAM), dynamic random-access memory (DRAM), and static random-access memory (SRAM).

Operating systems 114 manage hardware resources and may provide platforms for software execution at processors 106. Operating systems 114 may perform scheduling algorithms (e.g., round-robin and multilevel queues), allocate memory via virtual memory management and paging mechanisms, and facilitate interprocess communication (IPC) via message queues, pipes, and shared memory. Operating systems 114 may implement preemptive multitasking, real-time scheduling for deterministic latency, and dynamic power management to improve performance and power consumption of processors 106.

Proximity assessment module 118 may make proximity determinations based on contextual information. For example, proximity assessment module 118 may receive contextual information of one or more computing devices (e.g., computing device 100A and/or computing device 100B). Proximity assessment module 118 may then determine, based on the contextual information, whether a distance between computing device 100A and another computing device satisfies a proximity threshold.

Computing system 140 may be a system or network of computing devices configured to provide services to other devices. For example, computing system 140 may be a cloud system that provides computing services, storage services, networking services, database services, and/or application hosting services to one or more computing devices, such as computing device 100A and computing device 100B. Computing system 140 may include distributed computing resources managed by virtualization technologies, container orchestration platforms, and/or serverless computing frameworks. Additionally, computing system 140 may use load balancing, fault tolerance, and redundancy techniques to increase system availability.

Computing system 140 may host association repository 142. Association repository 142 may be a database or application associating two or more computing devices. In some implementations, association repository 142 may group computing devices based on a device identifier. For example, computing device 100A and computing device 100B may each be associated with a device identifier, where association repository 142 indicates that the respective device identifier belongs to a common group of device identifiers. In this way, computing system 140 may receive a device identifier and, based on the device identifier, identify a set of computing devices associated with the device identifier. Additionally, or alternatively, association repository 142 may group devices belonging to a user account. In this way, computing system 140 may receive an account identifier (e.g., user information and/or a user account number) and, based on the account identifier, identify a set of computing devices associated with the account identifier.

According to various aspects of the present disclosure, computing device 100B may generate contextual information. The contextual information may include, for example, location information and/or local network information. The location information may indicate a location of computing device 100B. For instance, the location information may be GPS data that indicates a location of computing device 100B. Additionally, or alternatively, the location information may indicate a general geographic location of computing device 100B, e.g., a geographic landmark, street, postal address, building, story of a building, or room within a building.

The contextual information may include local network information of computing device 100B. For instance, the contextual information may indicate Wi-Fi sources and/or Bluetooth sources available for connecting to computing device 100B. In some examples, the contextual information may include a set of Service Set Identifiers (SSIDs) and/or a Basic Service Set Identifier (BSSIDs) of one or more networks that computing device 100B is connected to or otherwise detects via communication component 108B.

Computing device 100B may transmit the contextual information to computing system 140 via communication component 108B. In some implementations, computing device 100B may transmit the contextual information based on a credential information synchronization schedule. For instance, computing device 100B may be configured to periodically provide (e.g., transmit) contextual information to computing system 140. Computing device 100B may then provide the contextual information to computing system 140, e.g., every three minutes. In some examples, computing device 100B may be configured to provide contextual information to computing system 140 responsive to an event. For instance, computing device 100B may transmit the contextual information to computing system 140 responsive to processors 106B exiting a sleep state. In still some examples, computing device 100B may provide contextual information to computing system 140 in response to receiving a request from computing system 140, e.g., a request for contextual information.

Computing system 140 may receive contextual information from computing devices other than computing device 100B, e.g., computing system 140 may also receive contextual information from computing device 100A. In response to receiving contextual information from a first device, computing system 140 may distribute the contextual information to one or more devices of a set of devices associated with the first device. Computing system 140 may determine the set of associated devices based on information stored at association repository 142. For instance, association repository 142 may store user account information of various user accounts, where one user account is linked to both computing device 100A and computing device 100B. In this example, computing system 140 may receive contextual information from computing device 100B and may provide the contextual information of computing device 100B to other account devices, e.g., computing device 100A.

Computing device 100A may determine whether a distance between computing device 100A and computing device 100B satisfies a proximity threshold by comparing at least a portion of the contextual information of computing device 100A with at least a portion of the contextual information of computing device 100B. For example, the contextual information may include location information of a respective computing device. Computing device 100A may determine that the distance between computing device 100A and computing device 100B satisfies the proximity threshold if the location information of computing device 100A and computing device 100B indicates that computing device 100A is within a threshold distance of computing device 100B, e.g., 30 meters.

In some implementations, the location information may indicate a general geographic location, e.g., a geographic landmark, street, postal address, building, story of a building, or room within a building. For instance, the location information of computing device 100B may indicate that computing device 100B is at Building ABC. The location information of computing device 100A may indicate that computing device 100A is at ABC Park. Computing device 100A may determine that the distance satisfies the proximity threshold if the geographic location of computing device 100A and the geographic location of computing device 100B indicates that computing device 100A is within a threshold distance of computing device 100B. In this example, computing device 100A may use navigation data to determine that the proximity threshold is satisfied based on determining that Building ABC is within a threshold distance to ABC Park.

Determining whether the distance between computing device 100A and computing device 100B satisfies the proximity threshold may be based on local network information included in the contextual information. For instance, if a same local network (e.g., Wi-Fi source or Bluetooth source) is available to both computing device 100A and computing device 100B, computing device 100A may determine that the distance between computing device 100A and computing device 100B satisfies the proximity threshold. If computing device 100A and computing device 100B share no available local networks, computing device 100A may determine that the distance between computing device 100A and computing device 100B does not satisfy the proximity threshold. Similarly, in some implementations, if computing device 100A and computing device 100B are connected to a same local network, computing device 100A may determine that the distance between computing device 100A and computing device 100B satisfies the proximity threshold. If computing device 100A and computing device 100B are not connected to a same local network, computing device 100A may determine that the distance between computing device 100A and computing device 100B does not satisfy the proximity threshold.

In response to determining that the distance satisfies the proximity threshold, computing device 100A may broadcast an advertisement message enabling wireless communication between computing device 100A and computing device 100B. For instance, computing device 100A may transmit, via communication components 108A, wireless communication protocol advertisement message broadcasts such as Bluetooth requests (e.g., pairing or bonding requests) and/or Wi-Fi Direct requests. Responsive to receiving the broadcast via communication components 108B, computing device 100B may initiate a wireless communication channel between computing device 100B and computing device 100A. The wireless communication channel may enable computing device 100B to provide information to and receive information from computing device 100A. In response to determining that the distance between computing device 100A and computing device 100B does not satisfy the proximity threshold, computing device 100A may stop transmitting advertisement message broadcasts.

As discussed, computing device 100A may receive, from computing system 140, contextual information of multiple devices. Computing device 100A may similarly determine whether the distance between computing device 100A and each device satisfies the proximity threshold based on the respective contextual information. Computing device 100A may broadcast one or more advertisement messages based on determining that one device or a threshold amount of the multiple devices satisfies the proximity threshold. Additionally, or alternatively, computing device 100A may stop broadcasting advertisement messages based on determining that no devices or a threshold amount of devices do not satisfy the proximity threshold.

According to various aspects of the present disclosure, computing device 100A may be configured to only broadcast advertisement messages when a device is within a suitable range to receive the broadcasts advertisement messages. Because other devices (e.g., computing device 100B) may wirelessly connect to computing device 100A without computing device 100A remaining in an advertisement broadcasting state, computing device 100A may conserve compute resources. For example, some techniques include periodically transmitting advertisement message broadcasts from an advertising device regardless of whether other devices are within range to wirelessly connect with the advertising device. Because computing device 100A may only broadcast advertisement messages responsive to determining that a distance to another device is within a proximity threshold, computing device 100A therefore may conserve significant battery power, processor utilization, and bandwidth associated with transmitting periodic advertisement message broadcasts.

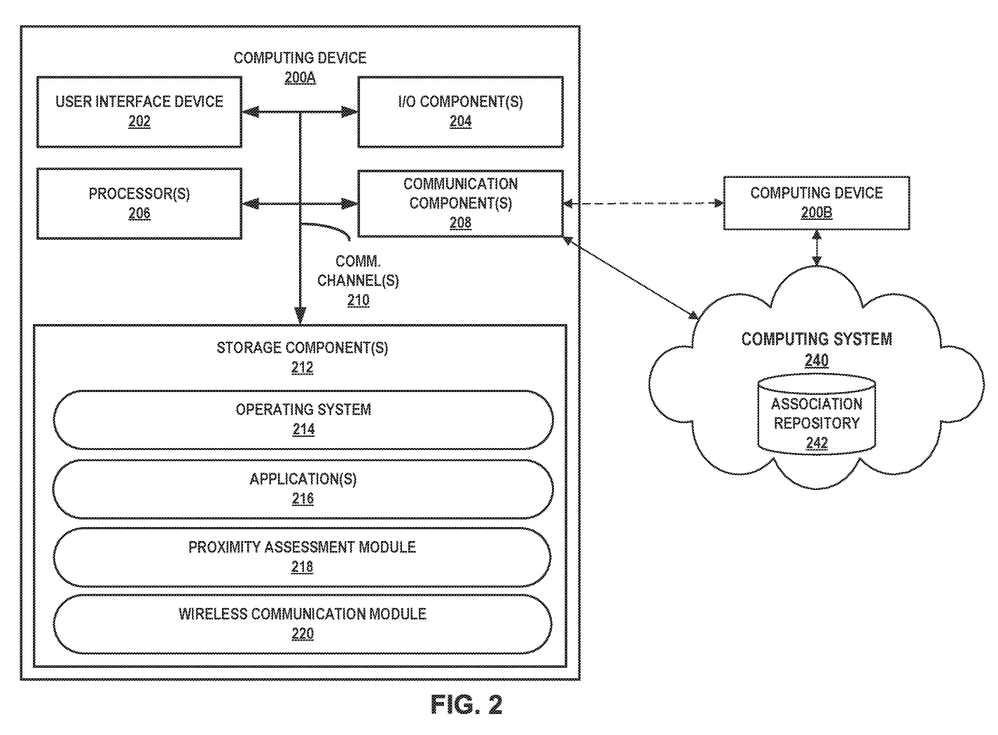

FIG. 2 is a conceptual diagram illustrating an example computing device in wireless communication with other computing elements, in accordance with one or more aspects of this disclosure. FIG. 2 includes computing device 200A and computing 200B (collectively, “computing devices 200”), where computing devices 200 may be individual mobile or non-mobile computing devices. Each computing device of computing devices 200 may be a mobile phone, a tablet computer, a laptop computer, a desktop computer, a server, a mainframe, a set-top box, a television, a wearable device (e.g., a computerized watch, computerized eyewear, computerized headphones, computerized gloves, computerized ring, etc.), a home automation device or system (e.g., an intelligent thermostat or home assistant device), a gaming system, a media player, an e-book reader, a mobile television platform, an augmented reality device, a virtual reality device, a mixed reality device, an automobile navigation or infotainment system, or any other type of mobile, non-mobile, wearable device, or non-wearable device configured to manage wireless communication channels in accordance with techniques of this disclosure. Computing devices 200 may implement various compute resources, such as processors, memory, data storage, data buses, input/output controllers, network interfaces, accelerators (e.g., graphics accelerators), and power management units.

Computing device 200A includes UI device 202. UI device 202 may function as an input and/or output device for computing device 200A and may be implemented using various technologies. For instance, UI device 202 may function as an input device using a presence-sensitive display, microphone technologies, infrared sensor technologies, or other input device technology for use in receiving user input. UI device 202 may function as an output device configured to present output to a user using any one or more display devices (e.g., a presence-sensitive display), speaker technologies, haptic feedback technologies, or other output device technology for use in outputting information to a user. In some implementations, UI device 202 may be a component of input/output (I/O) components 204.

One or more I/O components 204 may receive input and/or provide output for computing device 200A. I/O components 204 may provide output by, for example, making information perceivable to an external component or user. I/O components 204 may convert data produced by computing device 200A into a user-understandable or machine-interpretable format, such as a visual, audio, or physical format. Examples of output components of I/O components 204 include audio output devices (e.g., speakers and headphones), haptic output devices, printers, actuators, network interfaces, and storage devices. I/O components 204 may also provide input for computing device 200A by, for example, converting external signals into machine-readable formats. Examples of input components of I/O components 204 include game controllers, audio input devices (e.g., microphones), image input devices (e.g., cameras and scanners), thermometers, accelerometers, motion detectors, biometric devices, network interfaces, rotating crown buttons, push buttons, and storage devices.

One or more processors 206 may implement functionality and/or execute instructions within computing device 200A. For example, processors 206 may include one or more CPU, GPU, AP, DSP, NPU, ISP, or MCU. Processors 206 may implement computational components such as arithmetic logic units, control units, registers, pipelines, execution cores, caches (e.g., L1, L2, and L3), and branch predictors. Processors 206 may operate based on a fetch-decode-execute cycle, where processors 206 retrieve instructions from memory, decode the instructions into operations, and execute the instructions via various functional units. Further, processors 206 may implement instruction sets that define software and hardware communication at a binary level. In some implementations, each processor of processors 206 may include multiple cores and may support multiple threads, and may perform techniques such as parallel processing, graphics rendering, and multimedia processing.

One or more communication components 208 of computing device 200A may communicate with external devices via one or more wired and/or wireless networks by transmitting and/or receiving network signals on the one or more networks. Examples of communication components 208 include network interface cards (e.g., Ethernet cards), optical transceivers, radio frequency transceivers, GPS receivers, or any other type of device that can send and/or receive information. Other examples of communication components 208 may include short wave radios, cellular data radios, wireless network radios, as well as USB controllers.

Communication channels 210 may interconnect each of UI device 202, communication components 208, processors 206, I/O components 204, and storage components 212 for inter-component communication (physically, communicatively, and/or operatively). In some examples, communication channels 210 may include a system bus, a network connection, an inter-process communication data structure, or any other method for communicating data.

Computing device 200A may write data to or read data from one or more storage components 212, where storage components 212 may store execution code and/or other data associated with OS 214, applications 216, proximity assessment module 218, and wireless communication module 220. Storage components 212 may include one or more hard disk drives, solid-state drives, hybrid drives, removable media drives, optical drives, and/or any other device configured to store information. In some implementations, storage components 212 may be configured for short-term storage of information as volatile memory and therefore may not retain stored contents if powered off. Examples of volatile memories include RAM, DRAM, and SRAM.

Processors 206 may execute program code associated with one or more of OS 214, applications 216, proximity assessment module 218, and wireless communication module 220. OS 214, applications 216, proximity assessment module 218, and wireless communication module 220 may perform operations described herein using software, hardware, firmware, or a mixture of hardware, software, and firmware residing in and/or executing at computing device 200A or processors 206. In some implementations, processors 206 may execute OS 214, applications 216, proximity assessment module 218, and wireless communication module 220 as virtual machines executing on underlying hardware, as one or more services of an OS or computing platform, and/or as one or more executable programs at an application layer of processors 206.

OS 214 manages hardware resources and may provide a platform for software execution at processors 206. OS 214 may perform scheduling algorithms (e.g., round-robin and multilevel queues), allocate memory via virtual memory management and paging mechanisms, and facilitate IPC via message queues, pipes, and shared memory. OS 214 may implement preemptive multitasking, real-time scheduling for deterministic latency, and dynamic power management to improve performance and power consumption of processors 206.

Applications 216 may be first-party, second-party, or third-party applications of computing device 200A. Applications 216 may extend software functionality of processors 206, where applications 216 may execute within an execution environment presented by OS 214. Applications 216 may, as a few examples, provide gaming services (e.g., video games), email services, web browsing services, texting and/or chat services, web conferencing services, video conferencing services, music services (including streaming music services), video services (including video streaming services), navigation services, weather services, word processing services, spreadsheet services, slide and/or presentation services, assistant services, text entry services, network access services, or any other application service.

Processors 206 may execute proximity assessment module 218. Proximity assessment module 218 may make proximity determinations based on contextual information. For example, proximity assessment module 220 may receive contextual information of one or more computing devices (e.g., computing device 200A and/or computing device 200B). Proximity assessment module 218 may then determine, based on the contextual information, whether a distance between computing device 200A and another computing device satisfies a proximity threshold.

Wireless communication module 220 may manage wireless communication between each of computing devices 200, as well as communication with other computing elements, e.g., computing system 240. In some implementations, wireless communication module 220 may establish and maintain communication channels using protocols associated with Wi-Fi, Bluetooth, and/or cellular networking (e.g., Long Term Evolution (LTE), 5G). Wireless communication module 220 may implement communication components 208 to send and receive wireless signals, and may use adaptive frequency selection, power control, and error correction techniques to improve signal integrity and transmission output based on network conditions.

According to various techniques of the present disclosure, computing device 200B transmits contextual information to computing system 240. Computing system 240 may determine, based on association repository 242 and/or an indicator (e.g., a device or account indicator) received from computing device 200B, a set of devices associated with computing device 200B. Computing system 240 may then transmit the contextual information to one or more of the set of devices. In this example, the set of devices includes computing device 200A.

Responsive to receiving contextual information of other devices, computing device 200A may determine whether a distance between computing device 200A and one or more other devices satisfies a proximity threshold. For instance, proximity assessment module 218 may compare the contextual information of computing device 200B with contextual information of computing device 200A. If the contextual information includes location information, proximity assessment module 218 may determine whether the location information of computing device 200A indicates that, based on the location information, the distance between computing device 200A and computing device 200B satisfies a proximity threshold. For example, if the location information indicates a distance of 200 meters between computing device 200A and computing device 200B, proximity assessment module 218 may determine that the distance satisfies the proximity threshold.

If the contextual information includes local network information, proximity assessment module 218 may determine whether the contextual information indicates that the same local network or local networks are available to both devices. For instance, if the contextual information indicates that the same local network (e.g., Wi-Fi, Bluetooth, or cellular source) is accessible to each of computing device 200A and computing device 200B, proximity assessment module 218 may determine that the distance between computing device 200A and computing device 200B satisfies the proximity threshold. If the contextual information indicates that no local networks are available to both computing device 200A and computing device 200B, proximity assessment module 218 may determine that the distance between computing device 200A and computing device 200B does not satisfy the proximity threshold.

In response to determining that the distance between computing device 200A and one or more other devices (e.g., computing device 200B) satisfies a proximity threshold, computing device 200A may broadcast an advertisement message enabling wireless communication between computing device 200A and the one or more other devices. For instance, wireless communication module 220 may transmit, via communication components 208, wireless communication protocol advertisement message broadcasts such as Bluetooth requests (e.g., pairing or bonding requests) and/or Wi-Fi Direct requests. Responsive to receiving the request(s), the one or more other devices may establish a communication channel with computing device 200A based on the request(s). For instance, in response to receiving Bluetooth request(s), the one or more other devices may establish a Bluetooth communication channel with computing device 200A. In response to receiving Wi-Fi Direct request(s), the one or more other devices may establish a Wi-Fi Direct communication channel with computing device 200A.

As discussed, computing system 240 may determine that computing device 200A is associated with computing device 200B. This determination may be based on determining that computing device 200A and computing device 200B are associated with a same user account. For instance, computing system 240 may receive, from computing device 200A, an identifier. The identifier may be associated with a user account. In some examples, the identifier may be a username, email address, phone number, device identifier, and/or any other information that may be indicative of the user account.

After receiving the identifier, computing system 240 may determine a set of devices associated with the identifier. For example, computing system 240 may receive, from a computing device, a user account identifier. The identifier may correspond to a user account having account information stored at association repository 242. Computing system 240 may determine that the user account is associated with other computing devices, e.g., computing device 200A. For instance, computing system 240 may determine that computing device 200A and computing device 200B correspond to a same set of devices associated with the user account.

In still some implementations, the identifier may be a device identifier. Computing system 240 may receive the device identifier and determine, based on information stored at association repository 242, one or more computing devices associated with the device identifier. For instance, the device identifier may be a unique device identification code associated with computing device 200B. Computing system 240 may determine, based on information stored at association repository 242, that computing device 200A and computing device 200B are both associated with the device identifier of computing device 200B. In this example, the information stored at association repository 242 may be a table of devices and corresponding device identification codes.

Computing device 200B may transmit contextual information to computing system 240 based on a credential information synchronization schedule. For example, computing device 200B may be configured to periodically provide contextual information to computing system 240. Computing device 200B may then provide the contextual information to computing system 240, e.g., every hour, every three minutes, every day, or every five days. Additionally, or alternatively, computing device 200B may transmit the contextual information to computing system 240 responsive to an event, e.g., a device wake event or an account login event. Computing device 200B may transmit contextual information to computing system 240 responsive to receiving a request from computing system 240. For instance, computing system 240 may request contextual information from each device of a set of devices identified by association repository 242 (e.g., each device associated with a user account). Responsive to receiving the request, each device of the set of devices may transmit contextual information to computing system 240.

In some implementations, processors 206 include a higher-power compute unit and a lower-power compute unit. The higher-power compute unit may be a primary processor and/or compute engine configured to perform resource-intensive tasks via a general-purpose instruction set. For instance, the higher-power compute unit may be an AP, CPU, or GPU. The lower-power compute unit may be a specialized processor and/or compute engine configured to perform tasks that are less resource-intensive than those performed by the higher-power compute unit. For instance, the lower-power compute unit may be an MCU, sensor hub, DSP, NPU, ISP, or any combination thereof. Additionally, or alternatively, the lower-power compute unit may be a subset of a primary processor. For instance, the lower-power compute unit may be an always-on core of a multi-core processor. The lower-power compute unit may support a specialized instruction set and may perform techniques such as image processing, lightweight control logic, and background processing.

The lower-power compute unit may be less computationally capable than the higher-power compute unit. For example, the lower-power compute unit may have a lower clock speed, a decreased core count, reduced instruction set capabilities, a smaller cache size, and/or less memory bandwidth than the higher-power compute unit. However, the lower-power compute unit generally consumes less power than the higher-power compute unit. For instance, the higher-power compute unit consumes more power to complete a task than lower-power compute unit consumes for the same task. To conserve power, computing device 200A may perform operations via the lower-power compute unit while the higher-power compute unit remains in a sleep state or idle state. The higher-power compute unit may wake to perform tasks according to a schedule or in response to receiving an unscheduled wake event.

The lower-power compute unit may perform various techniques of the present disclosure. For instance, the lower-power compute unit may execute program code of proximity assessment module 218 and/or wireless communication module 220. For instance, computing device 200A may receive contextual information of computing device 200B via computing system 240. The lower-power compute unit may then determine whether a distance between computing device 200A and computing device 200B satisfies a proximity threshold based on the contextual information. In some implementations, the lower-power compute unit may perform various techniques described with respect to this disclosure while the higher-power compute unit remains in a sleep state.

In some implementations, the contextual information includes credential information regarding the location of other devices that may potentially connect to computing device 200A. For example, computing device 200A may receive contextual information of various computing devices and may broadcast advertisement messages based on determining that one or more of the devices are within a threshold distance to computing device 200A. Rather than continually scanning (e.g., continually broadcasting advertisement messages), computing device 200A may enable or disable communication components 208 responsive to proximity determinations. In this way, computing device 200A may avoid broadcasting advertisement messages when no available devices are within a connection range of computing device 200A. For example, instead of periodically broadcasting advertisement messages (e.g., in 100ms or 250ms polling intervals), computing device 200A may only broadcast advertisement messages responsive to detecting another device via contextual information.

A subset of associated devices may implement techniques of the present disclosure. For example, a television plugged into a constant power source may continually offer pairing, while a watch may implement the described techniques to only offer pairing when another computing device is within a specified distance. In this example, the television may perceive the watch as unavailable for connection unless the watch begins broadcasting messages. Additionally, computing device 200A may use other information such as devices connected to a network as well as whether there are any devices to connect to. For example, if computing device 200A has no peer devices to connect to and/or has not received contextual information, proximity assessment module 218 and/or wireless communication module 220 may remain inactive until receiving contextual information.

In some implementations, computing system 240, instead of computing device 200A, may initiate advertisement message broadcasting based on distance determinations. For instance, computing system 240 may receive, via one or more network interfaces of computing system 240, contextual information of computing device 200A and contextual information of computing device 200B. For example, computing device 200B may send local network information associated with computing device 200B to computing system 240 and computing device 200A may send local network information associated with computing device 200A to computing system 240. Additionally, or alternatively, computing device 200B may send location information associated with computing device 200B to computing system 240 and computing device 200A may send location information associated with computing device 200A to computing system 240.

Computing system 240 may first determine that a set of devices, including computing devices 200, are associated via association repository 242. For instance, computing system 240 may identify the set of devices based on the devices being associated with a same user account. Then, for each device from the set of devices, computing system 240 may determine if the respective device is within a specified proximity to one or more of the other devices from the set of devices. For example, computing system 240 may determine whether a distance between computing device 200A and computing device 200B satisfies a proximity threshold by comparing at least a portion of the contextual information of computing device 200A with at least a portion of the contextual information of computing device 200B. In some examples, the contextual information may include location information of a respective computing device. Computing system 240 may determine that the distance between computing device 200A and computing device 200B satisfies the proximity threshold if the location information of computing device 200A and computing device 200B indicates that computing device 200A is within a threshold distance of computing device 200B, e.g., 50 meters.

Computing system 240 may cause one or more associated devices to begin broadcasting advertisement messages based on determining that the devices are within a specified proximity to each other. For instance, responsive to determining that the distance between computing devices 200 satisfies the proximity threshold, computing system 240 may transmit, to computing device 200A and/or computing device 200B, an indication to begin advertisement message broadcasting. Receiving the indication may cause computing device 200A and/or computing device 200B to broadcast an advertisement message enabling wireless communication channel initialization between computing device 200A and computing device 200B. Responsive to determining that the distance does not satisfy the proximity threshold, computing system 240 may transmit, to computing device 200A and/or computing device 200B, an indication to stop advertisement message broadcasting. Receiving the indication may cause computing device 200A and/or computing device 200B to stop broadcasting advertisement messages.

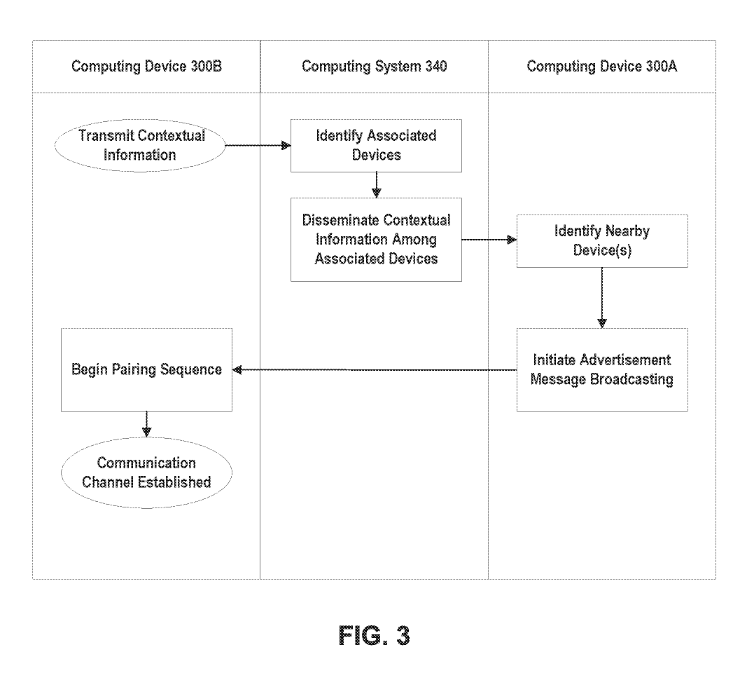

FIG. 3 is a swimlane diagram illustrating an example operation for establishing a wireless communication channel, in accordance with one or more aspects of this disclosure. As shown in FIG. 3, computing device 300B may transmit contextual information to computing system 340. For example, computing device 300B may transmit location information and/or local network information to computing system 340. The local network information may indicate one or more Wi-Fi sources and/or Bluetooth sources available for communicatively coupling with computing device 300B. Additionally, or alternatively, the local network information may indicate one or more Wi-Fi sources and/or Bluetooth sources communicatively coupled with computing device 300B.

Computing system 340 may then identify a set of devices associated with computing device 300B. For example, computing system 340 may identify one or more devices associated with a device identifier of computing device 300B and/or a user account identifier received from computing device 300B. Then, computing system 340 may disseminate contextual information among the set of associated devices. For instance, if computing system 340 receives contextual information from computing device 300B, computing system 340 may transmit the contextual information of computing device 300B to one or more other devices of the set of associated devices. Computing system 340 may transmit the contextual information along with other information. For instance, computing system 340 may be configured to periodically transmit credential information to a set of devices associated with a user account. Each time computing system 340 transmits the credential information, computing system 340 may transmit contextual information of one or more devices to one or more devices of the set of devices associated with the user account.

After receiving contextual information of one or more other devices from computing system 340, computing device 300A may identify nearby devices based on the contextual information. For example, computing device 300A may compare the received contextual information with contextual information of computing device 300A. If the received contextual information includes location information of computing device 300B, computing device 300A may determine whether location information of computing device 300A indicates that the distance between computing device 300A and computing device 300B satisfies a proximity threshold. If the received contextual information includes local network information of computing device 300B, computing device 300A may determine whether one or more same local networks are available to both devices. One or more same local networks being available to both devices may indicate that computing device 300A and computing device 300B are within a suitable distance to establish a direct connection.

Responsive to determining that a distance to computing device 300B satisfies a proximity threshold, computing device 300A may initiate advertisement message broadcasting. In response to receiving an advertisement message broadcast (e.g., a Bluetooth request, Wi-Fi Direct request, etc.), computing device 300B may begin a pairing sequence to establish a communication channel with computing device 300A.

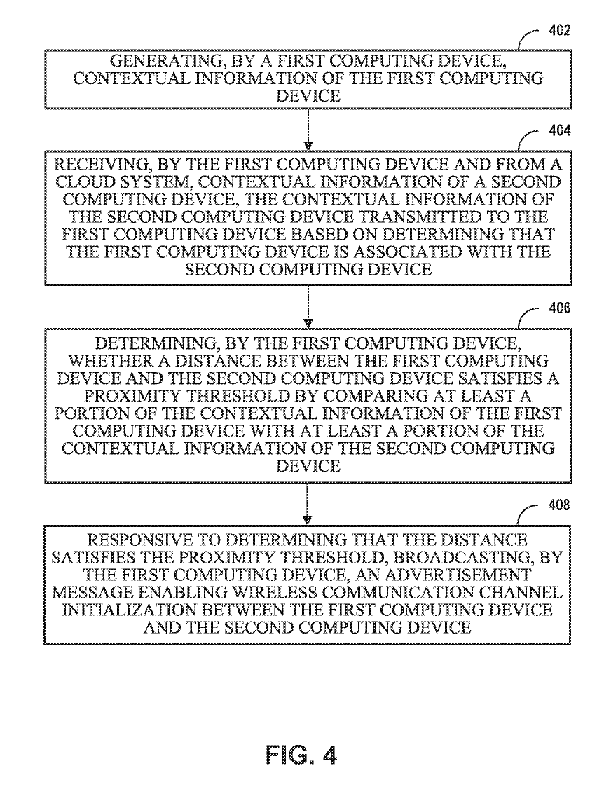

FIG. 4 is a flowchart illustrating an example operation for establishing a wireless communication channel, in accordance with one or more aspects of this disclosure. The example of FIG. 4 is described with respect to FIG. 2. A technique for establishing a wireless communication channel may include generating, by a first computing device, contextual information of the first computing device (402). For example, computing device 200A may generate contextual information including location information and/or local network information.

The technique may also include receiving, by the first computing device and from a cloud system, contextual information of a second computing device, the contextual information of the second computing device transmitted to the first computing device based on determining that the first computing device is associated with the second computing device (404). For instance, computing device 200A may receive contextual information of computing device 200B from computing system 240. Computing system 240 may have transmitted the contextual information to computing device 200A based on determining that computing device 200A is associated with computing device 200B.

The technique may further include determining, by the first computing device, whether a distance between the first computing device and the second computing device satisfies a proximity threshold by comparing at least a portion of the contextual information of the first computing device with at least a portion of the contextual information of the second computing device (406). For example, proximity assessment module 218 of computing device 200A may determine whether a distance between computing device 200A and computing device 200B satisfies a proximity threshold based on comparing contextual information of computing device 200A with contextual information of computing device 200B.

The technique may additionally include, responsive to determining that the distance satisfies the proximity threshold, broadcasting, by the first computing device, an advertisement message enabling wireless communication channel initialization between the first computing device and the second computing device (408). For instance, wireless communication module 220 of computing device 200A may cause communication components 208 to broadcast an advertisement message based on proximity assessment module 218 determining that the distance between computing device 200A and computing device 200B satisfies the proximity threshold.

Further to the descriptions above, a user may be provided with controls allowing the user to make an election as to both if and when systems, programs, or features described herein may enable collection of user information (e.g., information about a user’s social network, social actions, or activities, profession, a user’s preferences, or a user’s current location), and if the user is sent content or communications from a server (e.g., computing system 240). In addition, certain data may be treated in one or more ways before it is stored or used, so that personally identifiable information is removed. For example, a user’s identity may be treated so that no personally identifiable information can be determined for the user, or a user’s geographic location may be generalized where location information is obtained (such as to a city, ZIP code, or state level), so that a particular location of a user cannot be determined. Thus, the user may have control over what information is collected about the user, how that information is used, what information is provided to the user, and how, if at all, the various computing systems and computing devices of this disclosure collect or manage the user’s information.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. A computer program product may include a computer-readable medium.

By way of example, and not limitation, such computer-readable storage media may include random-access memory, read-only memory, EEPROM, CD-ROM or other optical disk storage, magnetic disk storage, or other magnetic storage devices, flash memory, or any other storage medium that may be used to store desired program code in the form of instructions or data structures and that may be accessed by a computer. Also, any connection is properly termed a computer-readable medium. For example, if instructions are transmitted from a website, server, or other remote source using a coaxial cable, fiber optic cable, twisted pair, digital subscriber line, or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors, general purpose microprocessors, application specific integrated circuits, field programmable logic arrays, or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit or a set of integrated circuits (e.g., a chip set). Various components, modules, or units are described in this disclosure to emphasize functional aspects of devices configured to perform the disclosed techniques, but do not necessarily require realization by different hardware units. Rather, various units may be combined in a hardware unit or provided by a collection of intraoperative hardware units, including one or more processors, in conjunction with suitable software and/or firmware.

It is to be recognized that, depending on the example, certain acts or events of any of the techniques described herein may be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In some examples, a computer-readable storage medium comprises a non-transitory medium. The term “non-transitory” indicates that the storage medium is not embodied in a carrier wave or a propagated signal. In certain examples, a non-transitory storage medium may store data that can, over time, change (e.g., in random-access memory or cache).

Example 1: A method includes generating, by a first computing device, contextual information of the first computing device; receiving, by the first computing device and from a cloud system, contextual information of a second computing device, the contextual information of the second computing device transmitted to the first computing device based on determining that the first computing device is associated with the second computing device; determining, by the first computing device, whether a distance between the first computing device and the second computing device satisfies a proximity threshold by comparing at least a portion of the contextual information of the first computing device with at least a portion of the contextual information of the second computing device; and responsive to determining that the distance satisfies the proximity threshold, broadcasting, by the first computing device, an advertisement message enabling wireless communication channel initialization between the first computing device and the second computing device.

Example 2: The method of example 1, wherein: the contextual information of the first computing device is location information of the first computing device; and the contextual information of the second computing device is location information of the second computing device.

Example 3: The method of example 1, wherein: the contextual information of the first computing device is local network information of the first computing device; and the contextual information of the second computing device is local network information of the second computing device.

Example 4: The method of any of examples 1 through 3, wherein the cloud system determines that the first computing device is associated with the second computing device based on determining that that the first computing device and the second computing device are associated with a same user account.

Example 5: The method of any of examples 1 through 4, wherein the second computing device transmitted the contextual information of the second computing device to the cloud system based on a credential information synchronization schedule.

Example 6: The method of any of examples 1 through 5, wherein the second computing device transmitted the contextual information of the second computing device to the cloud system responsive to receiving a request from the cloud system.

Example 7: The method of any of examples 1 through 6, wherein: the first device comprises a lower-power compute unit; and determining whether the distance between the first computing device and the second computing device satisfies the proximity threshold is performed by the lower-power compute unit.

Example 8: The method of any of examples 1 through 7, further comprising, responsive to determining the distance does not satisfy the proximity threshold, stopping, by the first computing device, an advertisement message broadcast.

Example 9: A first computing device includes one or more processors; and one or more storage devices storing instructions that, when executed by the one or more processors, cause the one or more processors to: generate contextual information of the first computing device; receive, from a cloud system, contextual information of a second computing device, the contextual information of the second computing device transmitted to the first computing device based on determining that the first computing device is associated with the second computing device; determine whether a distance between the first computing device and the second computing device satisfies a proximity threshold by comparing at least a portion of the contextual information of the first computing device with at least a portion of the contextual information of the second computing device; and responsive to determining that the distance satisfies the proximity threshold, broadcast an advertisement message enabling wireless communication channel initialization between the first computing device and the second computing device.

Example 10: The first computing device of example 9, wherein: the contextual information of the first computing device is local network information of the first computing device; and the contextual information of the second computing device is local network information of the second computing device.

Example 11: The first computing device of example 9, wherein: the contextual information of the first computing device is local network information of the first computing device; and the contextual information of the second computing device is local network information of the second computing device.

Example 12: The first computing device of any of examples 9 through 11, wherein the cloud system determines that the first computing device is associated with the second computing device based on determining that that the first computing device and the second computing device are associated with a same user account.

Example 13: The first computing device of any of examples 9 through 12, wherein the second computing device transmitted the contextual information of the second computing device to the cloud system based on a credential information synchronization schedule.

Example 14: The first computing device of any of examples 9 through 13, wherein the second computing device transmitted the contextual information of the second computing device to the cloud system responsive to receiving a request from the cloud system.

Example 15: The first computing device of any of examples 9 through 14, wherein: the one or more processors comprise a lower-power compute unit; and determining whether the distance between the first computing device and the second computing device satisfies the proximity threshold is performed by the lower-power compute unit.

Example 16: The first computing device of any of examples 9 through 15, wherein the one or more processors are further configured to, responsive to determining the distance does not satisfy the proximity threshold, stop, by the first computing device, an advertisement message broadcast.

Example 17: A non-transitory computer-readable storage medium comprising instructions, that when executed by one or more processors of a first computing device, cause the one or more processors to: generate contextual information of the first computing device; receive, from a cloud system, contextual information of a second computing device, the contextual information of the second computing device transmitted to the first computing device based on determining that the first computing device is associated with the second computing device; determine whether a distance between the first computing device and the second computing device satisfies a proximity threshold by comparing at least a portion of the contextual information of the first computing device with at least a portion of the contextual information of the second computing device; and responsive to determining that the distance satisfies the proximity threshold, broadcast an advertisement message enabling wireless communication channel initialization between the first computing device and the second computing device.

Example 18: The non-transitory computer-readable storage medium of example 17, wherein: the contextual information of the first computing device is location information of the first computing device; and the contextual information of the second computing device is location information of the second computing device.

Example 19: The non-transitory computer-readable storage medium of example 17, wherein: the contextual information of the first computing device is local network information of the first computing device; and the contextual information of the second computing device is local network information of the second computing device.

Example 20: The non-transitory computer-readable storage medium of any of examples 17 through 19, wherein the cloud system determines that the first computing device is associated with the second computing device based on determining that that the first computing device and the second computing device are associated with a same user account.

Example 21: The non-transitory computer-readable storage medium of any of examples 17 through 20, wherein the second computing device transmitted the contextual information of the second computing device to the cloud system based on a credential information synchronization schedule.

Example 22: The non-transitory computer-readable storage medium of any of examples 17 through 21, wherein the second computing device transmitted the contextual information of the second computing device to the cloud system responsive to receiving a request from the cloud system.

Example 23: The non-transitory computer-readable storage medium of any of examples 17 through 22, wherein: the one or more processors comprise a lower-power compute unit; and determining whether the distance between the first computing device and the second computing device satisfies the proximity threshold is performed by the lower-power compute unit.

Example 24: The non-transitory computer-readable storage medium of any of examples 17 through 23, wherein the instructions further cause the one or more processors to, responsive to determining the distance does not satisfy the proximity threshold, stop, by the first computing device, an advertisement message broadcast.

Example 25: A computing system comprising means for performing any combination of examples 1 through 8.

Example 26: A computer program product comprising one or more instructions that, when executed by a computing device, cause the computing device to perform any combination of examples 1 through 8.

Example 27: A method includes receiving, by a computing system and via the one or more network interfaces, contextual information of a first computing device and contextual information of a second computing device; determining, by the computing system, whether a distance between the first computing device and the second computing device satisfies a proximity threshold by comparing at least a portion of the contextual information of the first computing device with at least a portion of the contextual information of the second computing device; and responsive to determining that the distance satisfies the proximity threshold, transmitting, by the computing system and to the first computing device and via the one or more network interfaces, an indication to begin advertisement message broadcasting, wherein receiving the indication causes the first computing device to broadcast an advertisement message enabling wireless communication channel initialization between the first computing device and the second computing device.

Example 28: The method of example 27, wherein: the contextual information of the first computing device is location information of the first computing device; and the contextual information of the second computing device is location information of the second computing device.

Example 29: The method of example 27, wherein: the contextual information of the first computing device is local network information of the first computing device; and the contextual information of the second computing device is local network information of the second computing device.

Example 30: The method of any of examples 27 through 29, wherein the second computing device transmitted the contextual information of the second computing device based on a credential information synchronization schedule.

Example 31: The method of any of examples 27 through 30, wherein the second computing device transmitted the contextual information of the second computing device responsive to receiving a request from a cloud system.

Example 32: The method of any of examples 27 through 31, further comprising, responsive to determining the distance does not satisfy the proximity threshold, transmitting an indication to the first computing device, the indication causing the first computing device to stop an advertisement message broadcast.

Example 33: The method of any of examples 27 through 32, further comprising identifying the second computing device based on the second computing device being associated with a same user account as the first computing device.

Example 34: A computing system includes one or more network interfaces; one or more processors; and one or more storage devices storing instructions that, when executed by the one or more processors, cause the one or more processors to: receive, via the one or more network interfaces, contextual information of a first computing device and contextual information of a second computing device; determine whether a distance between the first computing device and the second computing device satisfies a proximity threshold by comparing at least a portion of the contextual information of the first computing device with at least a portion of the contextual information of the second computing device; and responsive to determining that the distance satisfies the proximity threshold, transmit, to the first computing device and via the one or more network interfaces, an indication to begin advertisement message broadcasting, wherein receiving the indication causes the first computing device to broadcast an advertisement message enabling wireless communication channel initialization between the first computing device and the second computing device.

Example 35: The computing system of example 34, wherein: the contextual information of the first computing device is location information of the first computing device; and the contextual information of the second computing device is location information of the second computing device.

Example 36: The computing system of example 34, wherein: the contextual information of the first computing device is local network information of the first computing device; and the contextual information of the second computing device is local network information of the second computing device.

Example 37: The computing system of any of examples 34 through 36, wherein the second computing device transmitted the contextual information of the second computing device based on a credential information synchronization schedule.

Example 38: The computing system of any of examples 34 through 37, wherein the second computing device transmitted the contextual information of the second computing device responsive to receiving a request from a cloud system.

Example 39: The computing system of any of examples 34 through 38, wherein the instructions further cause the one or more processors to, responsive to determining the distance does not satisfy the proximity threshold, transmit an indication to the first computing device, the indication causing the first computing device to stop an advertisement message broadcast.

Example 40: The computing system of any of examples 34 through 39, wherein the instructions further cause the one or more processors to identify the second computing device based on the second computing device being associated with a same user account as the first computing device.

Example 41: A non-transitory computer-readable storage medium comprising instructions that, when executed by one or more processors, cause the one or more processors to: receive, via one or more network interfaces, contextual information of a first computing device and contextual information of a second computing device; determine whether a distance between the first computing device and the second computing device satisfies a proximity threshold by comparing at least a portion of the contextual information of the first computing device with at least a portion of the contextual information of the second computing device; and responsive to determining that the distance satisfies the proximity threshold, transmit, to the first computing device and via the one or more network interfaces, an indication to begin advertisement message broadcasting, wherein receiving the indication causes the first computing device to broadcast an advertisement message enabling wireless communication channel initialization between the first computing device and the second computing device.

Example 42: The non-transitory computer-readable storage medium of example 41, wherein: the contextual information of the first computing device is location information of the first computing device; and the contextual information of the second computing device is location information of the second computing device.

Example 43: The non-transitory computer-readable storage medium of example 41, wherein: the contextual information of the first computing device is local network information of the first computing device; and the contextual information of the second computing device is local network information of the second computing device.

Example 44: The non-transitory computer-readable storage medium of any of examples 41 through 43, wherein the second computing device transmitted the contextual information of the second computing device based on a credential information synchronization schedule.

Example 45: The non-transitory computer-readable storage medium of any of examples 41 through 44, wherein the second computing device transmitted the contextual information of the second computing device responsive to receiving a request from a cloud system.

Example 46: The non-transitory computer-readable storage medium of any of examples 41 through 45, wherein the instructions further cause the one or more processors to, responsive to determining the distance does not satisfy the proximity threshold, transmit an indication to the first computing device, the indication causing the first computing device to stop an advertisement message broadcast.

Example 47: The non-transitory computer-readable storage medium of any of examples 41 through 46, wherein the instructions further cause the one or more processors to identify the second computing device based on the second computing device being associated with a same user account as the first computing device.

Example 48: A computing system comprising means for performing any combination of examples 27 through 33.

Example 49: A computer program product comprising one or more instructions that, when executed by a computing device, cause the computing device to perform any combination of examples 27 through 33.

What is claimed is:

1. A method comprising:
generating, by a first computing device, contextual information of the first computing device;
receiving, by the first computing device and from a cloud system, contextual information of a second computing device, the contextual information of the second computing device transmitted to the first computing device based on determining that the first computing device is associated with the second computing device;
determining, by the first computing device, whether a distance between the first computing device and the second computing device satisfies a proximity threshold by comparing at least a portion of the contextual information of the first computing device with at least a portion of the contextual information of the second computing device; and
responsive to determining that the distance satisfies the proximity threshold, broadcasting, by the first computing device, an advertisement message enabling wireless communication channel initialization between the first computing device and the second computing device.

2. The method of claim 1, wherein:
the contextual information of the first computing device is location information of the first computing device; and
the contextual information of the second computing device is location information of the second computing device.

3. The method of claim 1, wherein:
the contextual information of the first computing device is local network information of the first computing device; and
the contextual information of the second computing device is local network information of the second computing device.

4. The method of claim 1, wherein the cloud system determines that the first computing device is associated with the second computing device based on determining that that the first computing device and the second computing device are associated with a same user account.

5. The method of claim 1, wherein the second computing device transmitted the contextual information of the second computing device to the cloud system based on a credential information synchronization schedule.

6. The method of claim 1, wherein the second computing device transmitted the contextual information of the second computing device to the cloud system responsive to receiving a request from the cloud system.

7. The method of claim 1, wherein:
the first device comprises a lower-power compute unit; and
determining whether the distance between the first computing device and the second computing device satisfies the proximity threshold is performed by the lower-power compute unit.

8. The method of claim 1, further comprising, responsive to determining the distance does not satisfy the proximity threshold, stopping, by the first computing device, an advertisement message broadcast.

9. A computing system comprising:
one or more network interfaces;
one or more processors; and
one or more storage devices storing instructions that, when executed by the one or more processors, cause the one or more processors to:
receive, via the one or more network interfaces, contextual information of a first computing device and contextual information of a second computing device;
determine whether a distance between the first computing device and the second computing device satisfies a proximity threshold by comparing at least a portion of the contextual information of the first computing device with at least a portion of the contextual information of the second computing device; and
responsive to determining that the distance satisfies the proximity threshold, transmit, to the first computing device and via the one or more network interfaces, an indication to begin advertisement message broadcasting, wherein receiving the indication causes the first computing device to broadcast an advertisement message enabling wireless communication channel initialization between the first computing device and the second computing device.

10. The computing system of claim 9, wherein:
the contextual information of the first computing device is location information of the first computing device; and
the contextual information of the second computing device is location information of the second computing device.

11. The computing system of claim 9, wherein:
the contextual information of the first computing device is local network information of the first computing device; and
the contextual information of the second computing device is local network information of the second computing device.

12. The computing system of claim 9, wherein the second computing device transmitted the contextual information of the second computing device based on a credential information synchronization schedule.

13. The computing system of claim 9, wherein the second computing device transmitted the contextual information of the second computing device responsive to receiving a request from a cloud system.

14. The computing system of claim 9, wherein the instructions further cause the one or more processors to, responsive to determining the distance does not satisfy the proximity threshold, transmit an indication to the first computing device, the indication causing the first computing device to stop an advertisement message broadcast.

15. The computing system of claim 9, wherein the instructions further cause the one or more processors to identify the second computing device based on the second computing device being associated with a same user account as the first computing device.

16. A non-transitory computer-readable storage medium encoded with instructions that, when executed by one or more processors, cause the one or more processors to:
generate contextual information of a first computing device;
receive, from a cloud system, contextual information of a second computing device, the contextual information of the second computing device transmitted to the first computing device based on determining that the first computing device is associated with the second computing device;
determine whether a distance between the first computing device and the second computing device satisfies a proximity threshold by comparing at least a portion of the contextual information of the first computing device with at least a portion of the contextual information of the second computing device; and
responsive to determining that the distance satisfies the proximity threshold, broadcast an advertisement message enabling wireless communication channel initialization between the first computing device and the second computing device.

17. The non-transitory computer-readable storage medium of claim 16, wherein:
the contextual information of the first computing device is location information of the first computing device; and
the contextual information of the second computing device is location information of the second computing device.

18. The non-transitory computer-readable storage medium of claim 16, wherein:
the contextual information of the first computing device is local network information of the first computing device; and
the contextual information of the second computing device is local network information of the second computing device.

19. The non-transitory computer-readable storage medium of claim 16, wherein the cloud system determines that the first computing device is associated with the second computing device based on determining that that the first computing device and the second computing device are associated with a same user account.

20. The non-transitory computer-readable storage medium of claim 16, wherein the second computing device transmitted the contextual information of the second computing device to the cloud system based on a credential information synchronization schedule.
